(19) United States
(12) Patent Application Publication
(10) Pub. No.: US 2016/0156874 A1
(43) Pub. Date: Jun. 2, 2016

(54) Methods and Systems for Collaborative Messaging

(71) Applicant: Myndbee Inc., Irving, TX (US)

(72) Inventors: Mahesh Rajagopalan, Irving, TX (US); Amarendra Sahu, Bengaluru (IN); Jitendra Jagadev, Bengaluru (IN); Vishwakarma Desai, Bengaluru (IN); Rajesh Srivathsa, Bengaluru (IN)

(21) Appl. No.: 14/953,085

(22) Filed: Nov. 27, 2015

Related U.S. Application Data
(60) Provisional application No. 62/086,647, filed on Dec. 2, 2014.
(60) Provisional application No. 62/137,258, filed on Mar. 24, 2015.

(51) Int. Cl. H04N 7/14; G06T 11/60; H04L 29/08

(52) U.S. Cl. CPC H04N 7/141; H04L 67/104; G06T 11/60

(57) ABSTRACT

The method and system make it possible for devices that may not be co-located to capture information such as images, videos, text, audio, speech, location, etc. and create a composite image therefrom. The method and system includes a session initiated by one of the devices to other devices through a central server and/or by peer-to-peer network to synchronize the capture of information across all the devices. The method and system makes it possible to either synchronize the capture of information at each device or allow for preset time differences when each device captures information or allow for such time differences to be random or otherwise uncontrolled.

### BACKGROUND

The methods and systems in this invention apply to messaging and information exchange systems that are used by people to communicate between a plurality of devices and/or computers. Methods and systems are presented for communicating with participants in a manner that allows for coordination of the timing of capture of information from each participant, centrally processing the information from each participant, and coordinating the delivery of the processed information to each participant's mobile device and/or computer.

Mobile messaging systems allow users on mobile devices such as mobile phones, tablets, and mobile computers to communicate with one another individually and as groups. Many of today's systems emerged as improvements on the Short Message Service (SMS) offered by telecom carriers and Instant Messaging (IM) services offered by early Internet companies. Examples of today's mobile messaging systems include: iMessage, WhatsApp, Line, Diffr, and SnapChat, to name a few. Services such as iMessage and WhatsApp allow for the exchange of text, audio snippets, images, and videos to enhance and facilitate better messaging. Others, such as Line, enable the use of custom emoticons and stickers to help users personalize their messages and be more expressive. Services such as Diffr add richness to the communications by allowing participants to slip on a variety of identities rather than only messaging as themselves. Still others, such as SnapChat, focus their service almost exclusively on the participants' use of self-images (“selfies”) as the medium of messaging.

However, today's messaging services lack an important feature that could enhance the user experience of “so far, yet so near”—a true composite image experience. Here, by composite image experience, we mean the ability for participants who are not co-located to have a shared experience at the same moment in time as the other participants. For example, in one manifestation of the invention, self-images or selfies are dynamically coordinated to be taken at the same instant of time for all participants even though they may not be geographically co-located. Such selfies are then processed centrally and each participant receives a composite image consisting of a collage of all of their selfies. In another manifestation, composite images are created as collages of a series of selfies (each taken at the same instant of time or over a short period of time but in different physical locations) and presented to each participant as a moving image video or a “flipbook” video.

### SUMMARY OF THE EMBODIMENTS

The current invention describes methods and systems that address the composite image and/or information experience. While what is discussed in this disclosure is a composite image, video, text, audio and combinations thereof could comprise the composite image experience. The current invention is a composite image app that makes it possible for devices that may not be co-located to capture information such as images, videos, text, audio, speech, and location and compile those images into a single composite image. The methods include a real-time session initiated by one of the devices to other devices through a central server and/or by peer-to-peer means to synchronize the capture of information across all the devices. The invention makes it possible to either completely synchronize the capture of information at each device or allow for preset time differences when each device captures information or allow for such time differences to be random or otherwise uncontrolled and/or left to each device and user's discretion.

Once the information is captured across the devices, it can be processed and sent or sent as-is to each device. For example, images could be merged or a collage could be created. Location information could be superimposed on a map and a new location image could be created.

### BRIEF DESCRIPTION OF THE DRAWINGS

The accompanying drawings, wherein like-referenced numerals are employed to designate like parts or steps, are included to provide further understanding of the invention and are incorporated in and constitute a part of this specification, illustrate embodiments of the invention and, together with the description, serve to explain the principles of the invention.

FIG. 1 shows one use scenario of an embodiment of the invention where a plurality of users employ a composite image app running on their mobile devices to communicate images between them. A central server on the Internet is involved in the communications.

FIG. 2 shows a similar scenario as FIG. 1, but without a central server. All composite image communication is peer-to-peer between the apps.

FIG. 3 shows a setup similar to FIG. 1, but with some of the users utilizing composite image apps running on wearable devices and a desktop computer.

FIG. 4 shows a setup similar to FIG. 1, but with one of the users replaced by a computer program sending or receiving composite images.

FIG. 5 shows components of the composite image app.

FIG. 6 shows components of the server that was depicted in FIGS. 1, 3, and 4.

FIG. 7 shows the typical communication components of a composite image representation used by the composite image app.

FIG. 8 shows the typical components of a participant representation used by the composite image app.

FIG. 9 shows a representation similar to FIG. 7 but with some of the participants corresponding with a computer program rather than with a real person user.

FIG. 10 shows components of a message representation used by the composite image app.

FIG. 11 shows actions that could possibly take place in a composite image during its lifetime.

FIG. 12 shows steps involved in creating a composite image.

FIG. 13 shows a screen shot of the Waiting for Other Participants screen in the composite image app.

FIG. 14 shows a screen shot wherein a composite image app user has received an invitation to join a group to create a composite image.

FIG. 15 shows a screen shot of the composite image app posing screen, wherein a user is getting ready to provide picture information to create a message or image that will become part of the group's composite image.

FIG. 16 shows a screen shot of a composite image app message created from four images collected at the same time.

FIG. 17 shows a screen shot of a composite image app message containing photos and graphics.

FIG. 18 shows a screen shot of a feature of the composite image app that allows the sender to change the time given to invitees to participate in a composite image collaboration session.

FIG. 19 shows a screen shot of a composite image app feature that allows the sender to set the maximum time that participants are allowed to join and participate in a composite image collaboration session.

FIG. 20 shows a screen shot of the composite image app feature that allows users to capture and send photographs.

FIG. 21 shows a screen shot of the composite image app wherein multiple images have been captured during a collaboration session.

FIG. 22 shows a screen shot of a gallery composite images captured.

FIG. 23 shows a screen shot of the notifications feature of the second embodiment of the composite image app.

### DETAILED DESCRIPTION OF THE EMBODIMENTS

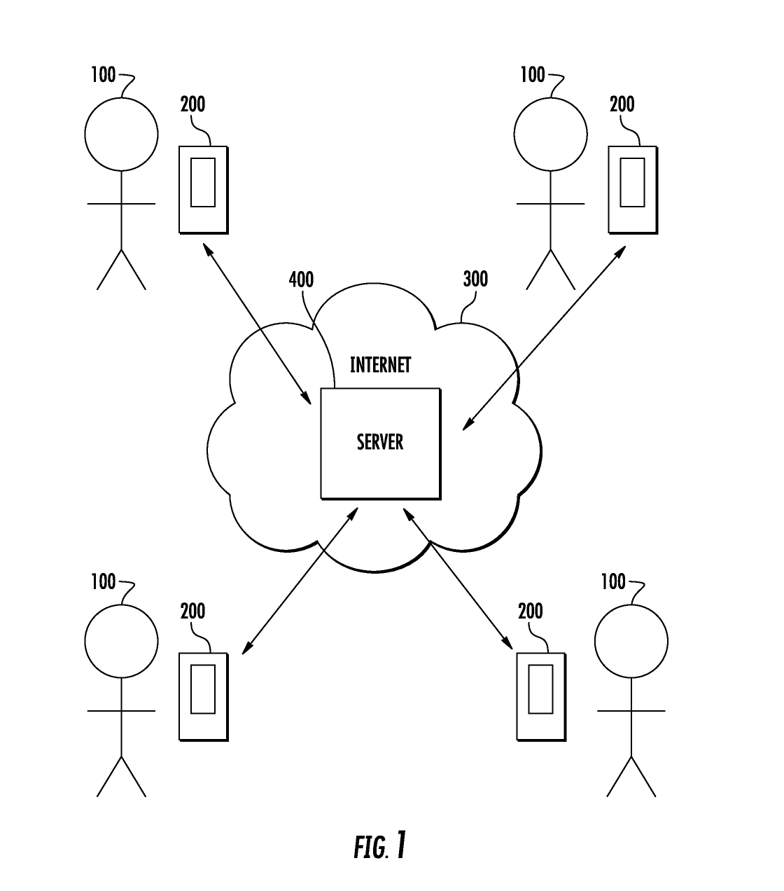

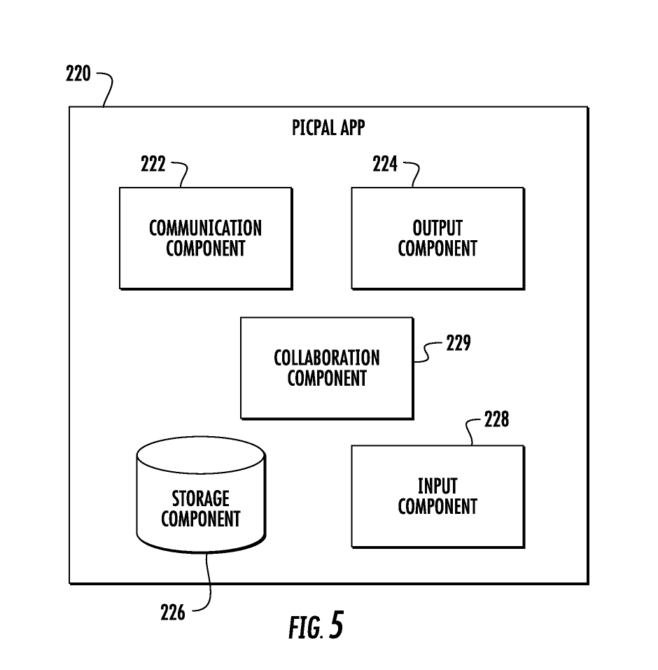

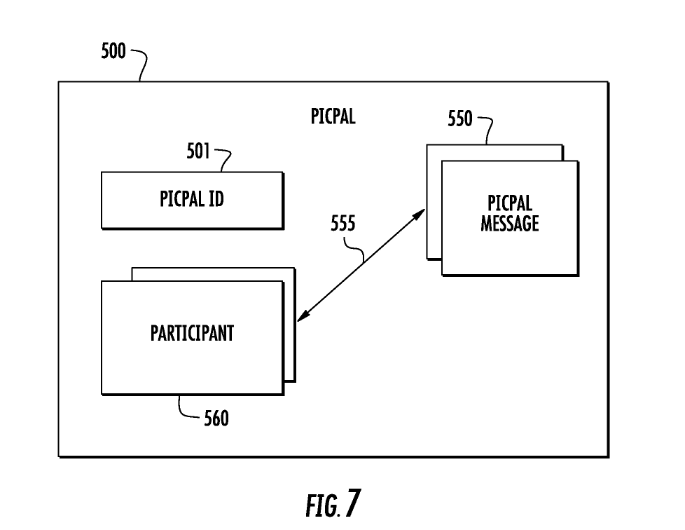

FIG. 1 shows a use scenario of a composite image creation application. A plurality of users 100 employ their mobile devices 200, which can be any mobile device capable of capturing and displaying images or videos or voice or text, executed by a computer program and communicating over a computer network, for example, a smart phone or a tablet. A composite image app 220 (FIG. 5), is running on each of the mobile devices 200. Users 100 can use the composite image app 220 (FIG. 5) to create composite images with other users 100. Messages 550 (FIG. 7) are exchanged over the Internet 300. A server 400 accessible over the Internet 300 is involved in the exchange 555 (FIG. 7) of the messages 550 (FIG. 7).

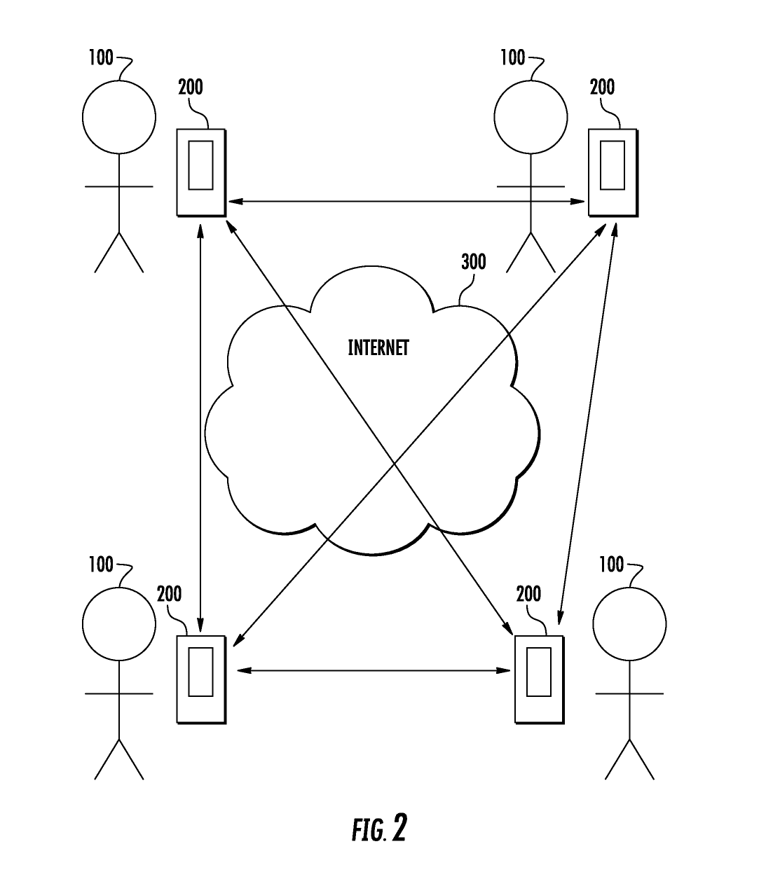

FIG. 2 shows another possible use scenario. In this scenario, the composite image app 220 may run on a mobile devices 200 to communicate peer-to-peer without involvement of a central server 400 (FIG. 1). Any information that would be stored on the server 400 (FIG. 1) may now be stored in a distributed manner over the composite image app 220 (FIG. 5) peers.

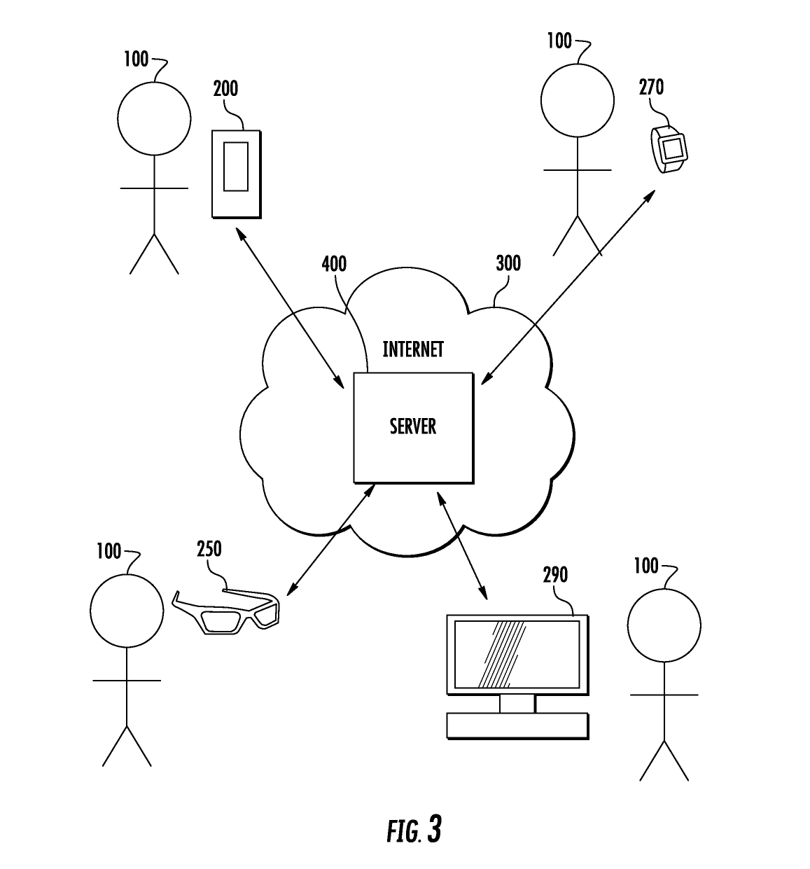

FIG. 3 illustrates that the composite image app 220 (FIG. 5) is not limited to use on mobile devices 200 only. The composite image app 220 (FIG. 5) can be implemented on any computing device that is able to communicate over a computer network. These options include: physical computing devices, like personal desktop computers, laptops, netbooks, and wearable devices, as well as virtual computing devices, e.g., ECMAScript-enabled Web browsers. This scenario is illustrated in FIG. 3, which is similar to FIG. 1, but with one of the mobile devices 200 replaced by a desktop computer 290, and two other mobile devices 200 replaced by wearable devices 250, 270. Similarly, a desktop computer 290, or wearable device 250, 270 could replace any or all mobile devices in a peer-to-peer scenario such as the one shown in FIG. 2.

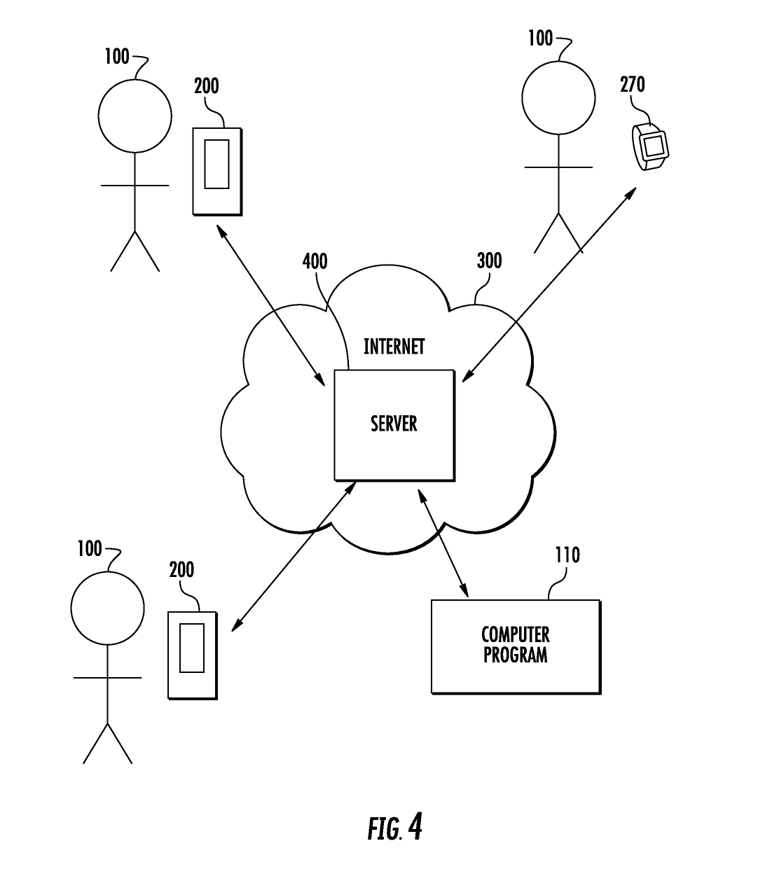

FIG. 4 shows a possible scenario where a user 100 of the app is replaced by a computer program 110. The computer program 110 can incorporate the functionality of the composite image app, for example, by including the composite image app's code in a form of software library, as is illustrated in FIG. 4 or it can communicate with a stand-alone composite image app, or an equivalent composite image app service, via an API, using means known to a person or ordinary skill in the art.

An example of the scenario shown in FIG. 4 may occur when the computer program 110 originates creation of some of the composite image messages 550 (FIG. 7) by monitoring a source of activity on the Internet 300 and automatically initiating a composite image message when specific types of events occur. An example where the computer program 110 compiles the composite image message is when it monitors the composite image messages that it receives and posts some of them to a social media website, such as Instagram or Facebook. A specific example would be captured images involving a news event or concert.

FIG. 5 shows certain functional components of the composite image app 220. The output component 224 allows a user 100 to access composite image app collaboration sessions 500 (FIG. 7). The output component 224 may also directly connect to a screen to communicate information to the user, but it can also connect to other devices, for example, a transmitter to communicate the information to a wearable device or a projector to communicate to a screen. The output component 224 may also use audio output, video output, or other output to communicate the information to the user. The input component 228 allows the user 100 to provide commands to the composite image app 220. It allows the user 100 to perform many actions, including: creating a new composite image collaboration session 500, controlling the view, editing a composite image, or creating or editing a composite image app message 550, as well as other actions enabled by the composite image app 220. The input component 228 can be implemented as a camera, microphone, keyboard, keypad, touch screen, computer pointing device, or any other means of interacting with a computing device, including a combination of these input mechanisms.

Again referring to FIG. 5, the storage component 226 stores the data from the composite image collaboration session 500 (FIG. 7) and other data needed to support the functionality of the composite image app 220. The extent of the data stored in the storage component 226 depends on the embodiment of the invention and specific use scenarios. In an embodiment supporting the use scenario illustrated in FIG. 5, the data stored in the storage component 226 may be limited to transient data as shown on the output component 224 or entered via the input component 228. In another embodiment, the data stored in the storage component 226 may include all the composite image app messages 550. In an embodiment supporting a peer-to-peer use scenario like the one illustrated in FIG. 2, the storage component 226 may store a portion of the distributed state of all live composite image app collaboration sessions 500 (FIG. 7) shared among the users 100 (FIG. 1).

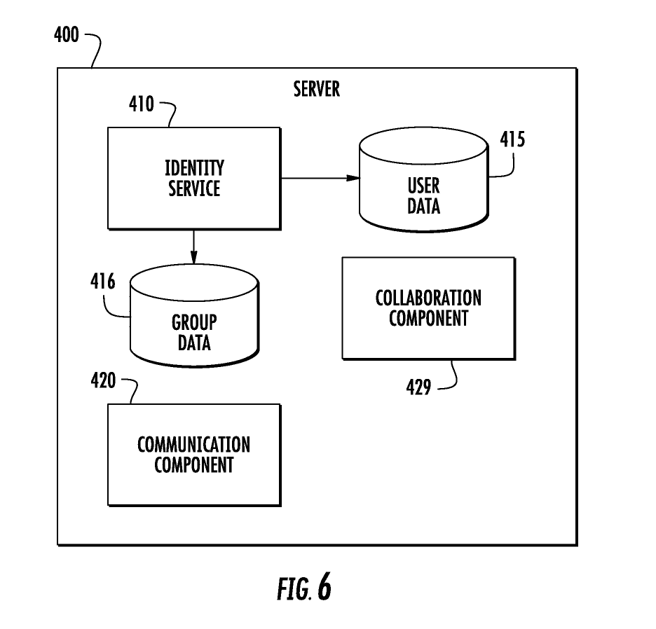

Still referring to FIG. 5, the collaboration component 229 may perform multiple functions: controlling the times of capture and the types of information captured, such as images, videos, text, audio, speech, and location information, via the input component 228; displaying composite image app messages 550 via the output component 224; allowing for the deletion of composite image app messages. The collaboration component 229 of the composite image app 220 communicates with the collaboration component 429 of the server 400 in order to coordinate the generation and display of composite image messages 550 across participants 560 of a composite image collaboration session 500 (see FIGS. 6 and 7).

Again referring to the composite image app 220 shown in FIG. 5, the app may be used in scenarios such as the one shown in FIG. 4 where a computer program 110 is involved. In this case, the output component 224 and the input component 228 work to support interaction with a computer program 110. A single-use scenario may include a plurality of embodiments of the composite image app; for example, one embodiment could be used by a human user 100 as another embodiment is used by a computer program 110.

Still referring to FIG. 5, the communication component 222 enables the composite image app 220 to send information used to create composite image app messages 550 to and receive composite image app messages from the devices 200 of other composite image app users 100. Depending on the use scenario (e.g., FIG. 1 versus FIG. 2), the communication component 222 will communicate either with a server 400 (FIG. 6) or with other composite image apps 220. In some embodiments a mixture of server-mediated and peer-to-peer communication may be used. Communication may be accomplished using either standard protocols like RTP or Websockets, for example, or using a proprietary protocol. Multiple protocols may be used to accomplish the communication.

The collaboration component 229 may enable the app 220 to coordinate the capture of composite image app messages 550 (FIG. 7) from other composite image apps 220 and the creation and distribution of composite image app messages 550 (FIG. 7). Depending on the use scenario, the collaboration component 229 will communicate either with a server 400 or with other composite image apps 220. If the use scenario is as seen in FIG. 2, the processing of information from each participant 560 (FIG. 7) to create a composite image message 550 will be distributed across composite image apps 220 (FIG. 5). In some embodiments a mixture of server-mediated and peer-to-peer communication may be used.

As shown in FIG. 6, the server 400 may contain a communication component 420 that is used to communicate with the communication component 222 of composite image apps 220. The server 400 may also contain an identity service 410. The identity service 410 uniquely identify users 100 of the composite image app 220. In a preferred embodiment of the invention, the app user 100's identity is tied to an identifier unique to a social media program like Facebook. In other embodiments, the app user's 100 identity could be tied to alternate, unique identifiers, e.g., a phone number, an email address, or a unique user name employed by all composite image app 220 users participating in a specific composite image app collaboration session 500.

The server 400 may also contain a collaboration component 429. In communicating with the collaboration component 229, the server's collaboration component 429: controls the times of capture and type of information captured, such as an image, series of images, video, text, location, or audio, by all participants 560 of a composite image app collaboration session 500; processes the information from each of the participants 560 of a composite image app collaboration session 500 to create a composite image app message 550; controls the time and duration of presentation of composite image app messages 550 across all participants 560 of a collaboration session 500; and controls the deletion of a collaboration session 500 across all participants 560. In an alternate embodiment, the collaboration component 429 controls the times of capture of information across all participants 560 so that the capture is synchronized as well as the time of delivery of the composite image app message 550 and the duration of presentation of the composite image app messages 550 to be synchronized independent of the geographic location of the individual participants 560. In alternate manifestations, the collaboration component 429 times the capture of information across participants 560 to be preset time differences or randomly chosen time differences or not control the capture at all. Similarly, the delivery of a composite image app message to participants 560 can be at preset time differences to each other or randomly chosen times or not controlled at all.

Still referring to FIG. 6, the collaboration component 429 of the server 400 may process each image received from participants 560 to create either a single composite image collage message 550 or a moving composite image app message 550 similar to that of a video but displayed as a set of animated images. In alternate manifestations, other information types such as text, audio, speech, videos, and location information could be combined from participants 560 who may or may not be geographically co-located to create a composite image app message 550. In an alternate embodiment, the collaboration component 429 may not do any processing at all and instead send the information to the composite image apps 220 of all the participants 560 without modifying or combining the information in any manner. The composite image app's collaboration component 229 will, in this case, combine the information.

The identity service 410 may store user-related information as user data 415. The user data 415 may include the name under which a user wants to be known within a system, the user's avatar, or the user's unique name. The user data 415 may also comprise information such as history of aliases used by the user and composite app participation history. In addition to user data 415, the preferred embodiment also stores group data 416. The group data 416 may define groups of users 100, and all the group attributes, such as name and visibility (privacy setting). Group data 416 may be used as a means of identifying multiple users 100, e.g., when adding new participants to a composite image app collaboration session 500.

Still referring to FIG. 6, although in the preferred embodiment identity service 410 is implemented in the server 400, the entirety or part of the functionality of the identity service 410 may be implemented in a distributed manner without using a central server.

FIG. 7 shows the typical components of a composite image app collaboration session 500 that can be communicated between the composite image apps 220 (FIG. 5). A composite image app collaboration session 500 comprises a composite image app collaboration session ID 501 that uniquely identifies the composite image app collaboration session, one or more composite image app messages 550, and a plurality of participant objects 560 that define which of the users 100 (FIG. 1) the composite image app collaboration session 500 is being distributed to. Though in the preferred embodiment there is a one-to-one relationship between a participant 560 and a user 100, other embodiments may allow many-to-many relationships, or may also map participants 560 to user groups as defined in group data 416. A composite image app collaboration session 500 may maintain the relationship 555 between the participants 560 and one or more composite image app messages 550. In other embodiments, a composite image app collaboration session 500 may also comprise other data used to reduce communication with the server 400 and reduce resource requirements of the server 400.

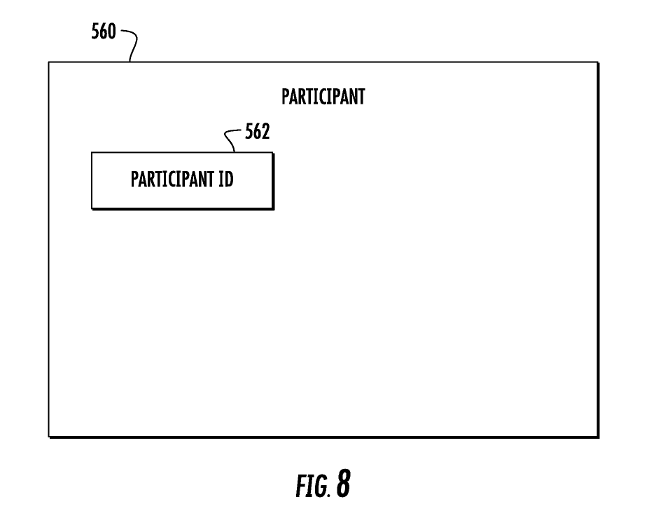

FIG. 8 shows the main components of a participant data object 560 in the preferred embodiment. A participant 560 may have a participant ID 562 that uniquely identifies one of the users 100. The identity service 410 may be used to determine each user's identity. In other embodiments, a participant 560 may also store, either complete or as references, user name, user avatars, or other user data.

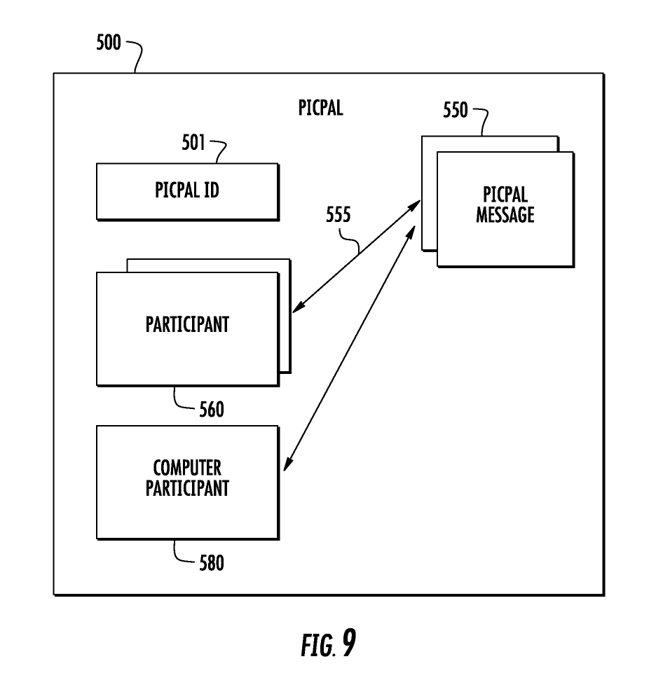

FIG. 9 shows a composite image app collaboration session 500 similar to FIG. 7, but in this case the session 500 also comprises one or more computer participants 580 corresponding to computer programs 110.

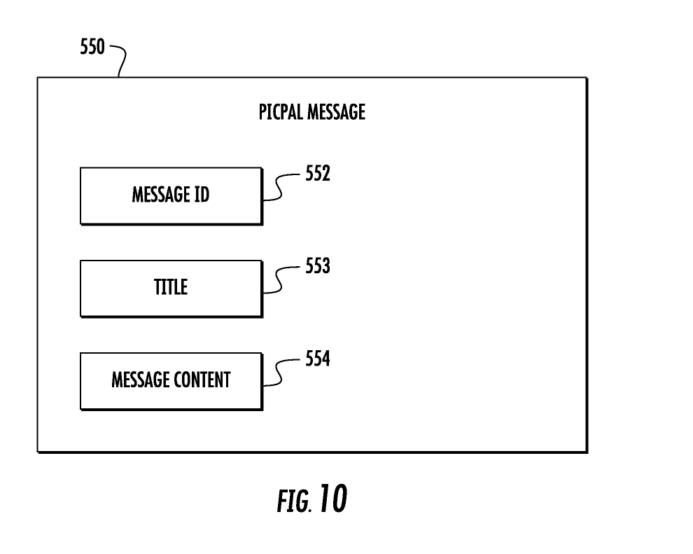

FIG. 10 shows the main components of a composite image app message 550 in the preferred embodiment. A composite image app message 550 comprises a Message ID 552 that uniquely identifies the composite image message 550. A composite image may 550 include a title 553 that can be either the participant names or another participant-chosen title of the composite image app message 550. A composite image app message 550 may also include message content 554 that may contain one or more of the following: text, images, emoticons, audio, video, drawings, doodles, and location information. Message content 554 may also be a processed combination of multiple text, images, emoticons, audio, video, drawings, doodles, and location information.

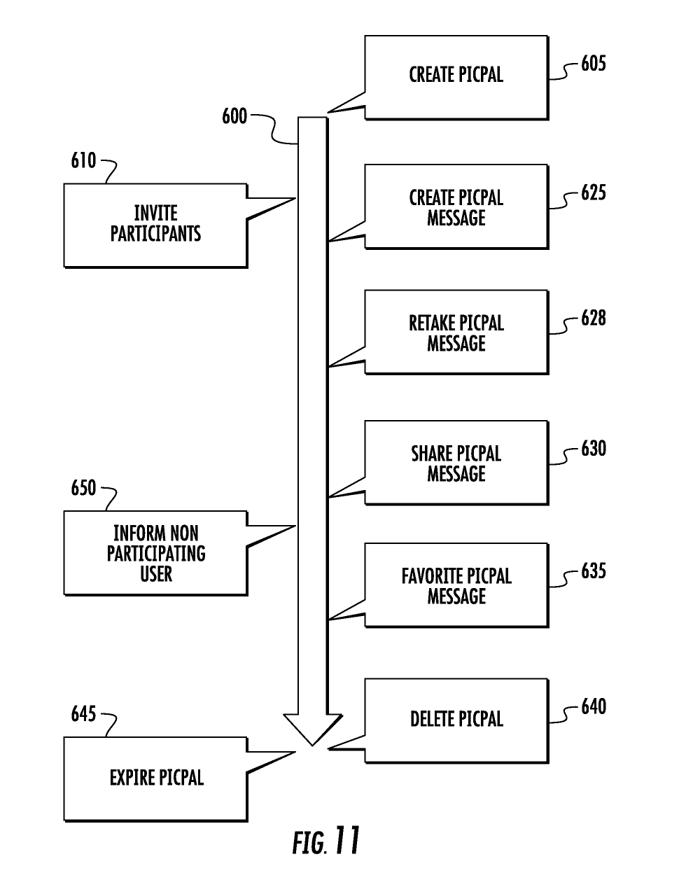

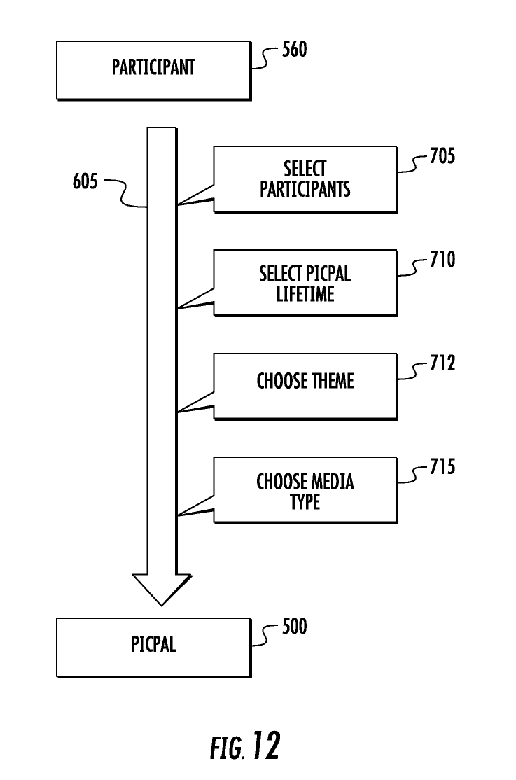

FIG. 11 shows actions possible in a composite image app collaboration session 500 during its lifetime 600. A composite image app collaboration session's 500 lifetime starts when it is created, a process that is demonstrated in FIG. 12. The creator of the composite image app collaboration session may invite participants 610 to participate in the collaboration session. The collaboration session 500 can be viewed by the users 100 identified as participants 560 of the collaboration session 500 until the collaboration session is deleted 640 or expires 645 when its preset lifetime has expired. During a collaboration session's lifetime 600 any participant 560 of the collaboration session 500 may: “favorite” a composite image app message 635, share a composite image app message 630 on any messaging system or social media such as Instagram or Facebook, or inform a non-participating user. Collaboration session participants 560 may create a message 625 or retake a message 628.

Before the lifetime for a session expires, a user may send second image data and the app would update the composite image by replacing the originally received image data with the second received image data.

FIG. 12 shows steps involved in creating a composite image app collaboration session 500. The process 605 of creating a composite image app collaboration session 500 by a participant 560 involves multiple steps that do not have to occur in the sequence outlined below and of course, some may be omitted. The steps may include the selecting of other participants 705 (Note that the creator of the collaboration session may automatically become one of the participants 560). Typically the participants 560 will be one or more users 100 known to the identity service 410; however, it is also possible to select other users as participants 560, and they will automatically be registered with the identity service. It is also possible to select participants 560 for a collaboration session 500 by identifying one or more user groups as defined by the group data 416.

Still referring to FIG. 12, another step in creating a composite image app collaboration session 500 may be selecting the lifetime of the collaboration session. In one embodiment, the composite image app 220 (FIG. 5) provides multiple options for the lifetime of the collaboration session 500. The creator of the collaboration session 500 can elect for it to be deleted automatically after a preset time or can elect for the collaboration session to be permanent.

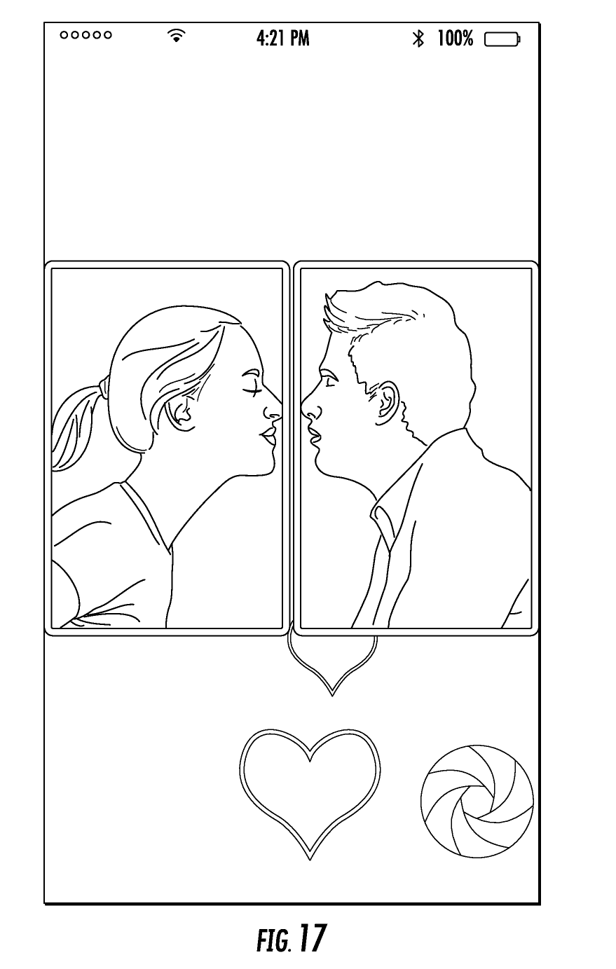

Referring again to FIG. 12, another step in creating a composite image app collaboration session 500 may be selecting the theme 712. The creator of the collaboration session 500 can choose the theme to convey to other participants the setting or ambience of the collaboration session 500 they want to create. One way for the creator to set the collaboration session's theme or ambience is to choose the media type, such as an image, series of images, video, location, text, emoticons, doodles, audio, or speech, including any combination of these. An example of a theme 1130 is shown in FIG. 17.

Once a composite image app collaboration session 500 is created, the collaboration component 229 may communicate the list of collaboration session participants 560 to the collaboration component 429 of the server 400. The collaboration component 429 may communicate with the composite image app's collaboration component 229 for the composite image participants 560 and invites them to participate in the collaboration session 500. The communication component 222 of the composite image app 220 used by each participant 560 who has chosen to participate in the collaboration session 500 will capture information via the input component 228 of that participant's composite image app 220. The communication component 222 of that participant's app sends the information captured to the communication component 420. The collaboration component 429 processes the information received from each participant 560 to create a composite image app message 550. The server's communication component 420 sends the composite image app messages 550 to the communication component 222 of the composite image app 220 of each participant who accepted the collaboration session invite. The collaboration component 229 in each participant's 560 composite image app 220 controls when the composite message 550 is provided to the output component 224.

In an embodiment, only the participants 560 listed in the composite image app collaboration session 500 who accepted the collaboration session invite (FIG. 17) may receive the collaboration image app message 550. Alternatively, non-participating users 100 may also receive communication from the composite image app 220, for example, to inform them about a collaboration session 500 with or without revealing the content. In this embodiment, these non-participating users are selected by the composite image app 220 from the contact list of a mobile device 200 or are entered explicitly by a participant 560 of the collaboration session 500. Other embodiments may implement other methods of selecting which non-participating users 100 should be informed about a collaboration session 500.

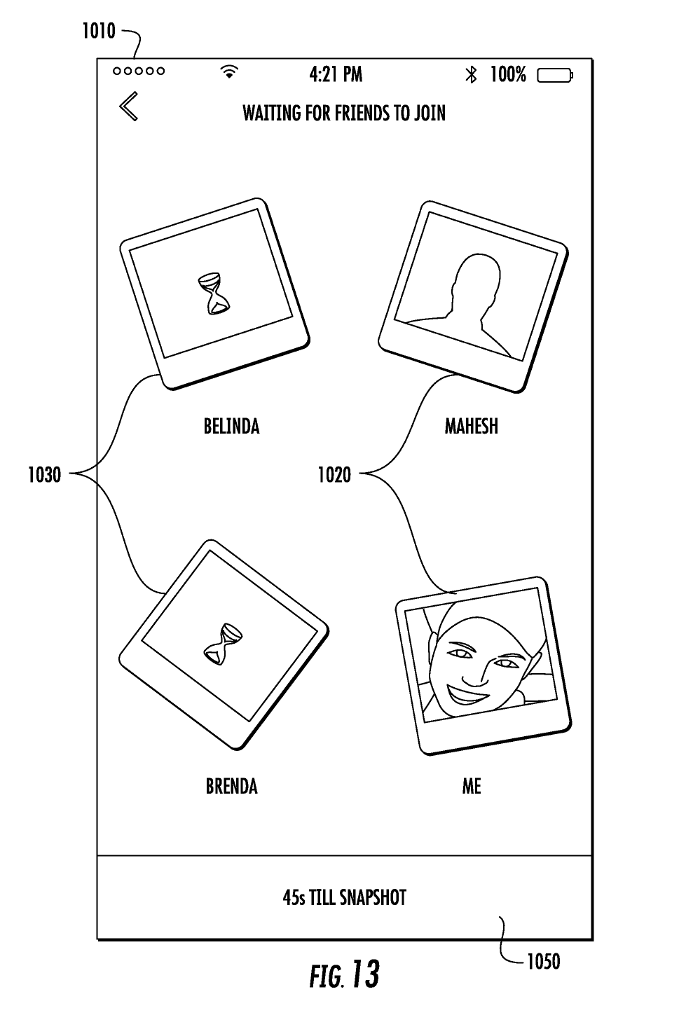

FIGS. 13-23 show various screen shots of the app in use.

FIG. 13 is a screen shot of the Waiting for Other Participants to join a collaboration session feature 1010 of the composite image app. This screen includes a segment at the bottom 1050 where the user can watch a time countdown before a snapshot is taken. This screen also shows invited users who have already arrived for the collaboration session 1020, as well as invited users who have not yet arrived 1030.

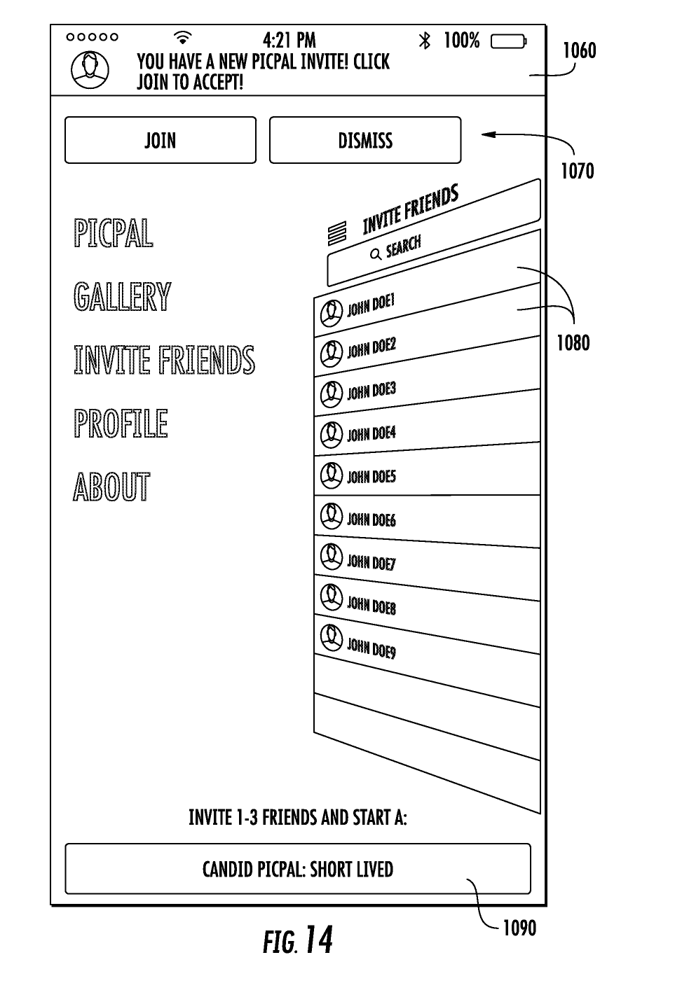

FIG. 14 is a screen shot that a composite image app user who has been invited to join a composite image app collaboration session would see alerting him to the new invitation. The new invitation notification 1060 is displayed at the top of the screen, below which the user has the option to “Join” the collaboration session or “Dismiss” 1070 the invitation. The screen displays the other users who have been invited to join the collaboration session. At the bottom of this screen, the type of collaboration session is displayed 1090, in this case, it is a “Candid Picpal: Short Lived” meaning that it will disappear at the end of a designated period of time (for example 1 minute or 24 hours) determined by the user who starts the collaboration session.

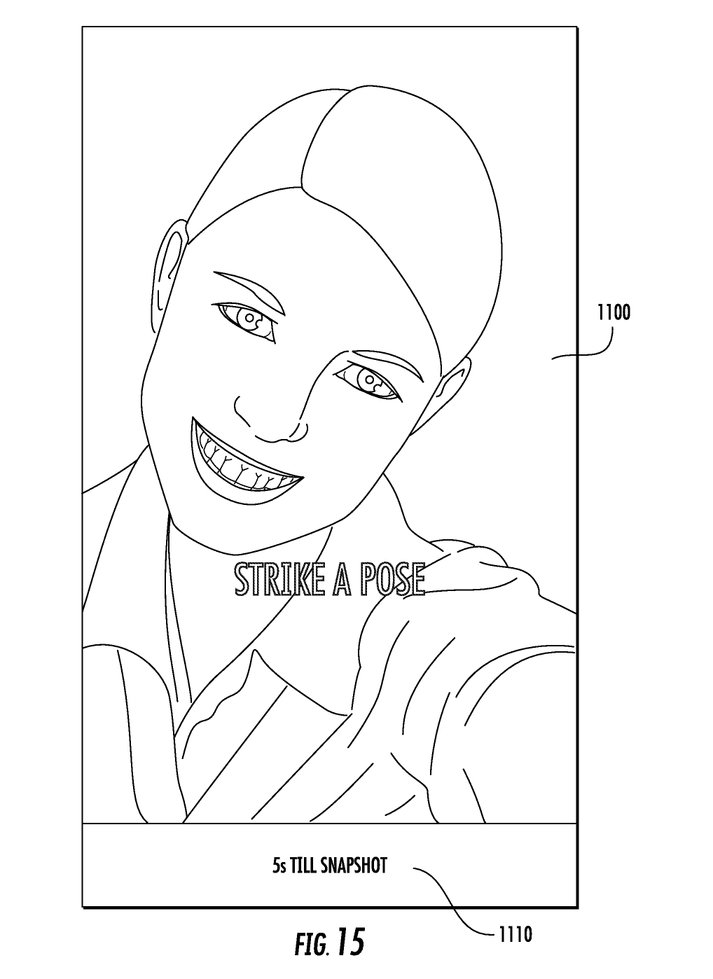

FIG. 15 shows the posing screen of the composite image app, wherein a user who has been invited to participate in a collaboration session is using the camera of her device to pose for a photo 1100. This participant is getting ready to provide picture information to create a composite image app message that will be included in a composite image collaboration session, in this case an image composite of herself. This screen also displays a countdown of the amount of time 1110 the user has to capture and share a contribution to the collaboration session.

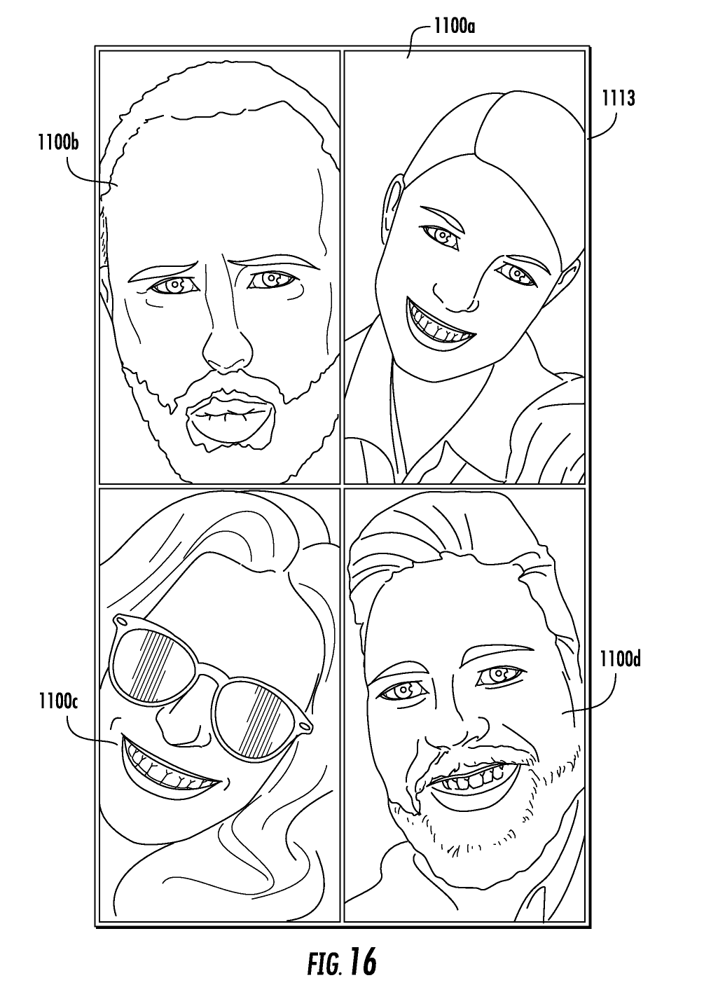

As seen in FIG. 16, a final collaboration session composite image 1113 is shown that includes captured images 1100a-d of four users including the user photo 1100.

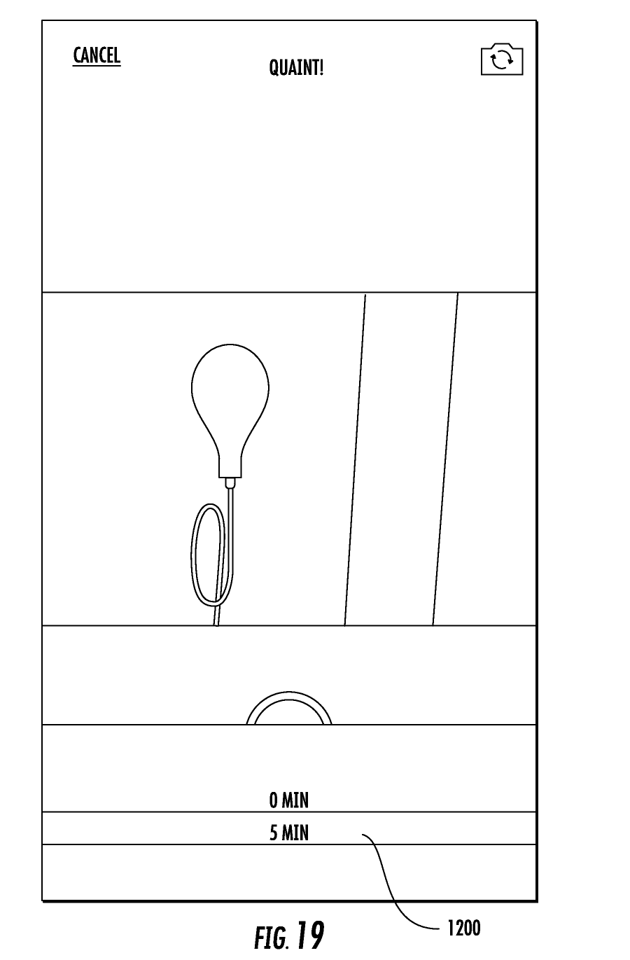

FIG. 17 shows a completed composite image app collaboration session message between two users who have each separately taken image composites 1120 of themselves and posted them. This screen shot shows a love theme 1130 for the collaboration session as conveyed by the use of images of hearts at the bottom. The live or almost-live feature of the posing screen (FIG. 19) may be useful in creating and editing the photographs for this collaboration session before the actual snapshot for the collaboration session composite image is captured. In other words, the participants in this case could use the live or almost-live feature to view a preview of the possible image capture in the composite image to make sure their lips were lined up as closely as possible to give the appearance that they were kissing.

In practice, a user can invite other users to participate in a composite image app collaboration session or search users to invite. Sign-up for the composite image app may be done by mobile number or preferably through Facebook or other social media applications.

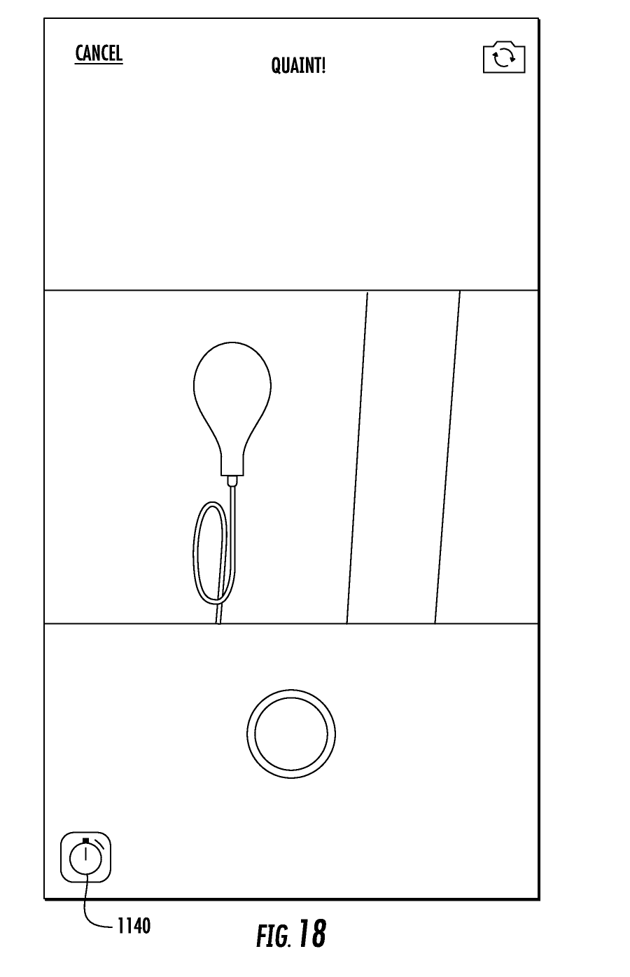

FIGS. 18 and 19 show screen shots that show a timing feature of the composite image app. In FIG. 18, clicking the clock icon 1140 in the bottom left-hand corner of the screen opens up a time adjustment option 1200 as seen at the bottom of the screen shown in FIG. 19. This feature of the app allows the user who creates the collaboration session 500 to set and then adjust, if necessary, the time 710 given to invitees of a collaboration session 500 to participate in it.

Still referring to the significance of the feature specified in FIG. 19, the app's time adjustment option gives the user 560 who creates the collaboration session 500 the ability to set a maximum time deadline 710 within which invitees 1080 can join and participate in the collaboration session 500. This time option can be adjusted with the creation of each new composite image app collaboration session.

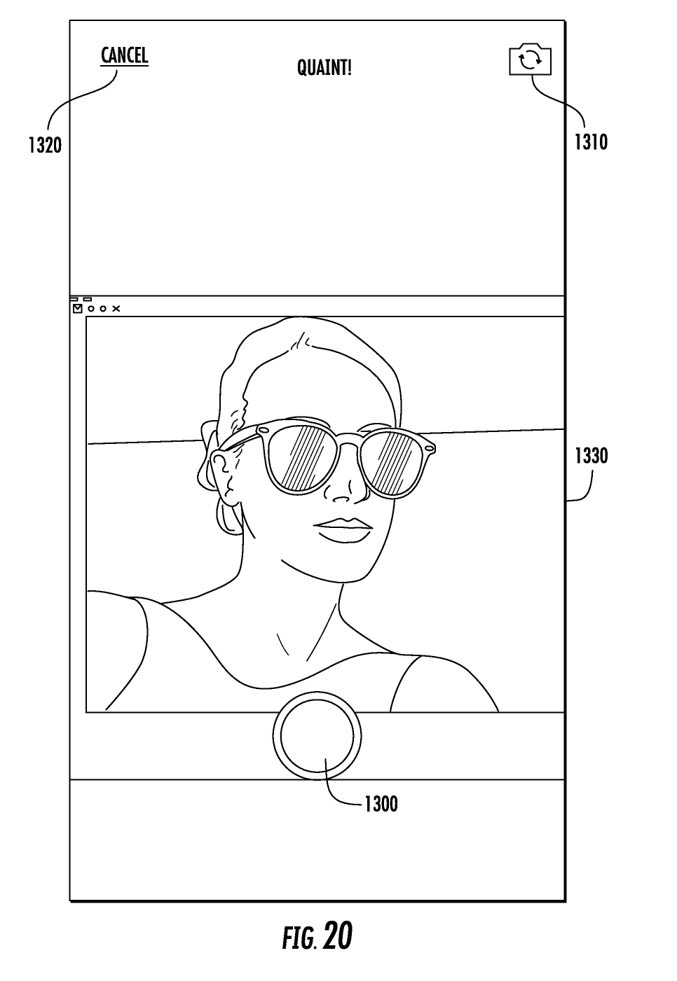

FIG. 20 shows a screen shot of a composite image app user's mobile device as it is being used to capture and send information (in this case, a photograph 1330) at any time of the user's choosing. In the case of photographs, the user can capture a picture by clicking on the camera shutter button 1300 of the mobile device. The composite image app user can also choose to take a photograph using the front camera or the back by clicking the camera icon 1310 seen at the top right corner of the screen. If the user decides against taking a photograph after arriving at this screen, pressing “Cancel” 1320 will close the mobile device's camera.

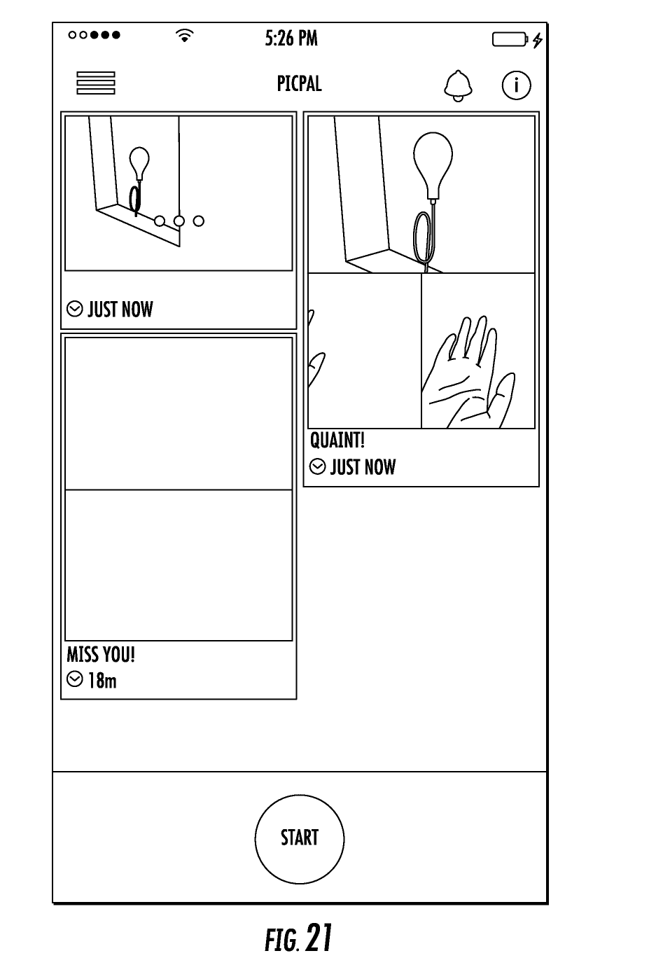

FIG. 21 shows a screen shot of an in-progress composite image app collaboration session 1400, where collaboration session photos 1410 are being downloaded from each participant's 560 (FIG. 9) device 200 at different times. Each framed photograph 1410, 1420, 1430 has been received into the collaboration session 1400 from a different participant 560 at unique times that are displayed by the time status 1440 at the bottom left corner of each of the images. In progress uploads may be shown with an upload status indicator 1450. The composite image app gives each user the liberty to capture pictures at a time of their choosing within the allotted timeframe 710 specified by the user 560 who created the collaboration session. During the time allotted by the user who created the collaboration session, participants are at liberty to continue capturing pictures at a time of their choosing and using the app in other ways to add to the collaboration session, including adding messages, browsing previous collaboration session messages or sending new ones. In an unexpired composite image session, a user may update their image, making the composite image a changing composite.

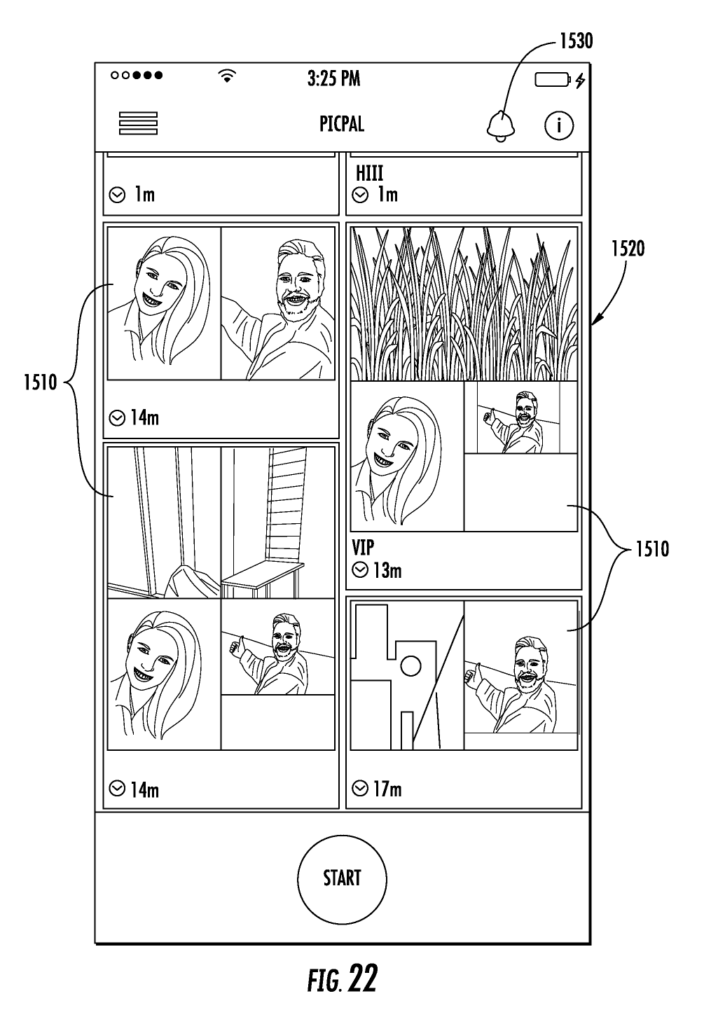

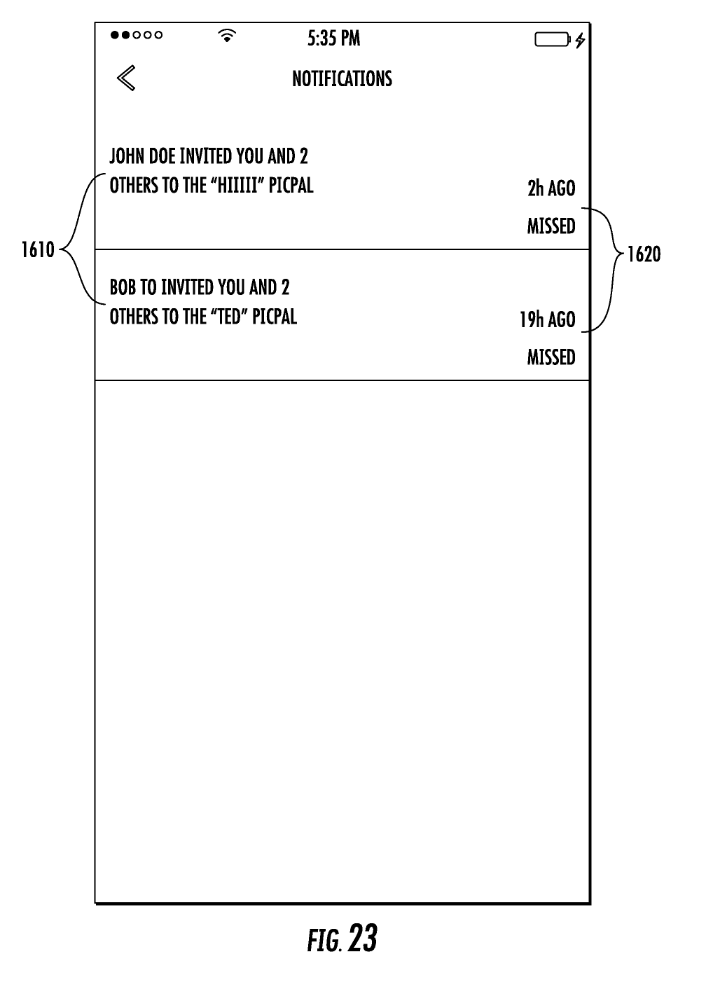

FIG. 22 is a screen shot of a composite image app collaboration session gallery 1520 of composite images 1510 assembled from different collaboration sessions 500 that a user has started or participated in. In FIG. 22, when a user clicks the “Bell” icon 1530 at the top right-hand corner of the screen, information related to the collaboration session, including incomplete responses to invites or other information related to the collaboration session, is displayed in the Notifications screen, as seen in FIG. 23.

FIG. 23 is a screen shot of the Notifications screen of the composite image app in further detail. This screen displays notifications on information such as missed, pending, and completed collaboration session invites 1610 and lists when each invite was received 1620.

A user can share the composite image or invite via social media links within the program, or share an image or link to an image by email or SMS message.

Those skilled in the art will appreciate that changes could be made to the embodiments described above without departing from the broad inventive concept thereof. It is understood, therefore, that this invention is not limited to the particular embodiments disclosed, but is intended to cover modifications within the spirit and scope of the present invention.

1. A method for creating a composite image from at least two images comprising:
initiating a composite image collaboration session by creating a composite image collaboration invitation in a first user device;
sending the composite image collaboration invitation to one or more recipients that have a user device capable of uploading image data;
receiving image data from the one or more recipients of the composite image collaboration invitation; and
creating a composite image that includes the received image data from the one or more recipients.

2. The method of claim 1, wherein the device is a mobile phone and the users are remote from one another.

3. The method of claim 1, wherein the image data comprises video data.

4. The method of claim 1, wherein the image data comprises audio data.

5. The method of claim 1, wherein the image data comprises text data.

6. The method of claim 1, wherein the image data comprises geographic data

7. The method of claim 1, wherein the image data comprises a combination of image, video, audio, and text data.

8. The method of claim 1, further comprising the step of setting a lifetime for a session such that once the lifetime expires, the first user device and one or more recipients user devices cannot send image data related to the composite image collaboration invitation.

9. The method of claim 8, wherein before the lifetime for a session expires, receiving updated image data from one or more recipients of the composite image collaboration invitation and updating the composite image by replacing the received image data with the updated received image data.

10. The method of claim 1, further comprising capturing the image data at the first user's and one or more recipient′ devices, wherein the image capturing step involves a live capture that allows the user and the one or more recipients to capture their image data in near-live time.

11. The method of claim 10, wherein during the capturing step, the user and one or more recipients can view a possible image capture appearance in the composite image.

12. A system for creating a composite image from at least two images comprising:
an input component initiating a composite image collaboration session by creating a composite image collaboration invitation in a first user device;
an output component ending the composite image collaboration invitation to one or more recipients that have a user device capable of uploading image data;
a communication component receiving image data from the one or more recipients of the composite image collaboration invitation; and
a coordination component creating a composite image that includes the received image data from the one or more recipients.

13. The system of claim 11, wherein the device is a mobile phone and the users are remote from one another.

14. The system of claim 11, wherein the image data comprises video data.

15. The system of claim 11, wherein the image data comprises audio data.

16. The system of claim 11, wherein the image data comprises text data.

17. The system of claim 1, wherein the image data comprises geographic data

18. The system of claim 11, wherein the image data comprises a combination of image, video, audio, and text data.

19. The system of claim 11, further comprising an input component capturing the image data at the first user's and one or more recipient′ devices, wherein the image capturing step involves a live capture that allows the user and the one or more recipients to capture their image data in near-live time.

20. The system of claim 19, wherein during the capturing, the user and one or more recipients can view a possible image capture appearance in the composite image.
